(19) United States
(12) Patent Application Publication
(10) Pub. No.: US 2023/0303413 A1
(43) Pub. Date: Sep. 28, 2023

(54) WATER TREATMENT CONTROL VALVE SYSTEM WITH TREATED WATER RETURNING TO THE SUPPLY WATER AND METHODS FOR USING SAME

(71) Applicant: R.E. Prescott Co., Inc., Exeter, NH (US)

(72) Inventor: Russell E. Prescott, Kingston, NH (US)

(21) Appl. No.: 18/189,395

(22) Filed: Mar. 24, 2023

Related U.S. Application Data
(60) Provisional application No. 63/269,841, filed on Mar. 24, 2022.

(51) Int. Cl. C02F 1/74; C02F 1/00

(52) U.S. Cl. CPC C02F 1/74; C02F 1/001; C02F 2201/005; C02F 2209/22

(57) ABSTRACT

A control valve system that allows treated water to return to the supply water may be used with a water treatment system that provides oxidant treatment to control oxidation and flow of water in accordance with various operating cycles. The control valve system causes treated water to flow from the outlet to the inlet of the control valve to provide treated water to an oxidant device to facilitate water treatment. The control valve system may also be configured to prevent untreated water from being directed to the oxidant device, for example, during a regeneration cycle of the water treatment system. The control valve system may further be used in a water treatment system that also provides an air charge.

### CROSS-REFERENCE TO RELATED APPLICATIONS

The present application claims the benefit of U.S. Provisional Application Ser. No. 63/269,841 filed Mar. 24, 2022, which is fully incorporated herein by reference.

### TECHNICAL FIELD

The present disclosure relates to water treatment systems and more particularly, to a control valve that allows treated water to return to the supply water through an oxidant device to facilitate regenerating a water treatment system with an oxidant, for example, during service without using a pump and during an oxidant regeneration cycle including rinse.

### BACKGROUND INFORMATION

Water treatment systems are commonly used in water supply systems. More common water treatment systems used in residential water supply systems, for example, include water softeners, acid neutralizers, iron/manganese removal systems, arsenic removal systems, hydrogen sulfide removal systems, and carbon filters. Some systems for treating high concentrations of iron, manganese, hydrogen sulfide gas or bacteria, pathogens, viruses, fungi etc. may use oxidant treatment such as air, ozonated air, ozonated water, potassium permanganate, hydrogen peroxide, or chlorine to treat or remove high concentrations of contaminants, such as bacteria, pathogens, viruses, fungi, iron, manganese, and sulfur from the water being supplied from a water supply (e.g., from a well or city water supply).

Homeowner and industry trends have moved away from oxidant devices such as liquid chemical feed systems, potassium permanganate feeders, solid chemical feed systems, and air pumps and moved toward chemical free aeration water treatment systems and aeration water treatment systems such as the water treatment system described in U.S. Pat. No. 8,691,091, which is commonly owned and incorporated herein by reference. Even with the advantages of releasing air during service and with the ability to regenerate with air during an air regeneration cycle, as described in U.S. Pat. No. 8,691,091, a drawback for these types of water treatment systems is that the air regeneration cycle (or an oxidant regeneration cycle) is not available during service to deliver an oxidant in proportion to oxygen demand unless a pump is added to the water treatment system. Another disadvantage of aeration water treatment systems is that, during the rinse regeneration cycle, the water treatment system is not providing an oxidant charge in proportion to oxygen demand, thereby depleting the water treatment system of its oxidant charge.

A further disadvantage of an aeration water treatment system when using an air ozone generator as an oxidant for regeneration is that poor air quality negatively affects air ozone generators. An air ozone generator service life is shortened by poor air quality, such as high humidity. High humidity reduces ozone concentration and production leading to premature failure of air ozone generators. Poor air quality can also lead to ozone reacting with chemicals in the air, such as those from building materials, carpets and printers, to form chemical byproducts that are put into the treated water and are harmful to health. Pre-treating air or using bottled air or oxygen generators to help mediate harmful byproducts is not practical or economical for residential applications. Additionally, for air ozone to be effective, it should mix well with the water to be treated and have sufficient contact time with water. Many commercial applications, to achieve ozone air contact and contact time with water, use high pressure circulating pumps to inject ozonated air and/or concentrated ozonated water through diffusers to create and recirculate micro bubbles of ozone in large batches of water before filtering the water. These types of diffusion systems may not be applicable to residential water supply systems. Therefore, ozone contacting the water is less efficient and this inefficiency interferes with accurately treating the water with oxidant in proportion to oxygen demand.

An option for an oxidant device in a water treatment system to facilitate the removal of these contaminants, which does not have the drawbacks of air ozone oxidant devices, includes oxidant devices that make ozone directly from water, such as the model E0S7210-Q made by BES Group PTY LTD Ground Floor in Australia and distributed by Biosure North America LLC. This type of system starts and stops with flow. The advantage of this type of oxidant device is that, rather than going through the difficulty of diffusing air ozone into water, this oxidant device generates the ozone directly from and in the water. Because this oxidant device uses water to generate ozone, it does not require cleaning the air of carpet and printer off gases. Consequently, this oxidant water mixture can be introduced to untreated water proportional to oxygen demand to create a homogenous treated mixture much like the way liquid chlorine feed pump systems or venturis can introduce concentrated chlorine into water.

A drawback with oxidation devices similar to those provided by BES, however, is that water containing high iron and manganese concentrations can interfere with water ozone production, foul the device, and shorten its service life. Therefore, there is a need for a system capable of feeding the oxidant device with treated water substantially free of iron and manganese to increase the service life of this type of oxidant device.

### SUMMARY

In accordance with an aspect of the present disclosure, a water treatment system includes at least one water treatment tank including a filter media for filtering water while in service and an oxidant control valve coupled to the water treatment tank for directing water in to and out of the water treatment tank during different operation cycles. The oxidant control valve includes an oxidant device and is configured to provide treated water from the water treatment tank to the oxidant device, wherein the treated water is oxidized to form oxidant water that provides an oxidant charge.

In accordance with another aspect of the present disclosure, oxidant control valve system includes a valve assembly configured to be coupled to a water treatment tank. The valve assembly includes a supply water inlet passage configured to receive water from a water supply, a service water outlet passage configured to direct water to a service water system, first and second tank passages configured to direct water in to or out of the water treatment tank, and a drain outlet passage configured to direct water from the water treatment tank to a drain. The valve assembly also includes a treated water return passage to control flow of water from the treatment tank to an oxidant device for oxidizing the treated water and a parallel fluid passage configured to divert at least some of the water from the supply water inlet passage and coupled to the treated water return passage to mix with oxidant water to form oxidized water and to supply the oxidized water to the water treatment tank. The valve assembly further includes a valve cycle actuator configured to provide fluid connections between the passages based on different positions of the valve cycle actuator during different operation cycles. At least one of the operations cycles includes providing treated water from the water treatment tank to the treated water return passage during an oxidant charge cycle.

In accordance with a further aspect of the present disclosure, a method of operating a water treatment system is provided. The method includes: treating the water in the water treatment system by directing water from a water supply to a water treatment tank; providing treated water from the water treatment tank to an oxidant device to oxidize the treated water; and supplying the oxidized treated water back to the water treatment tank mixed with supply water.

### BRIEF DESCRIPTION OF THE DRAWINGS

These and other features and advantages will be better understood by reading the following detailed description, taken together with the drawings wherein:

FIG. 1A is a schematic diagram of a water treatment system including an oxidant device coupled to a venturi aeration system and a control valve to direct treated water to the oxidant device, consistent with an embodiment of the present disclosure.

FIG. 1B is a schematic diagram of a water treatment system including an oxidant device and a control valve to allow an air charge into the control valve and an oxidant charge into the control valve without directing untreated water to the oxidant device, consistent with another embodiment of the present disclosure.

FIG. 1C is a schematic diagram of a water treatment system including an oxidant device and a control valve to allow an oxidant charge into the supply water without directing untreated water to the oxidant device, consistent with a further embodiment of the present disclosure.

FIG. 1D is a schematic diagram of a water treatment system including an oxidant device and a control valve to allow an oxidant charge into a treatment tank without directing untreated water to the oxidant device, consistent with yet another embodiment of the present disclosure.

FIG. 1E is a schematic diagram of a water treatment system including an oxidant device and a control valve to allow an air charge into the control valve and to allow an oxidant charge into the supply water without directing untreated water to the oxidant device, consistent with yet another embodiment of the present disclosure.

FIG. 1F is a schematic diagram of a water treatment system including an oxidant device and a control valve to allow an air charge into a treatment tank and to allow an oxidant charge into the treatment tank without directing untreated water to the oxidant device, consistent with yet another embodiment of the present disclosure.

FIG. 2A is a schematic view of a water treatment system illustrating flow of water during a service cycle including an oxidant control valve with an air charge connection and a passage for treated water to return to the supply water through an oxidant device, consistent with an embodiment of the present disclosure.

FIG. 2B is a schematic view of the water treatment system in FIG. 2A illustrating flow of water through the oxidant control valve during a service cycle with an oxidant charge.

FIG. 2C is a schematic view of the water treatment system in FIG. 2A illustrating flow of water through the oxidant control valve during a backwash regeneration cycle.

FIG. 2D is a schematic view of the water treatment system in FIG. 2A illustrating flow of water through the oxidant control valve during an air charge and oxidant regeneration cycle.

FIG. 2E is a schematic view of the water treatment system in FIG. 2A illustrating flow of water through the oxidant control valve during a rinse regeneration cycle with an oxidant charge.

FIG. 2F is a schematic view of a water treatment system including an oxidant control valve with a passage for treated water to return to a supply water inlet through an oxidant device, consistent with another embodiment of the present disclosure.

FIG. 3A is a cross-sectional view of an embodiment of an oxidant control valve configured to return treated water to supply water through an oxidant device, consistent with embodiments of the present disclosure, in a service cycle position.

FIG. 3B is a cross-sectional view of the oxidant control valve in FIG. 3A in a service cycle with oxidant charge position.

FIG. 3C is a cross-sectional view of the oxidant control valve in FIG. 3A in a backwash cycle position.

FIG. 3D is a cross-sectional view of the oxidant control valve in FIG. 3A in an oxidant charge cycle position.

FIG. 3E is a cross-sectional view of the oxidant control valve in FIG. 3A in an oxidant charge during rinse cycle position.

FIG. 3F is a cross-sectional view of an oxidant control valve configured to return treated water to a supply water inlet passage through an oxidant device, consistent with another embodiment of the present disclosure, in an oxidant charge during service cycle position.

FIG. 4 is a partially cross-sectional view of a check valve that may be used as a pressure opening device in the oxidant control valve, consistent with an embodiment of the present disclosure.

FIG. 5 is a side view of a venturi that may be used in the oxidant control valve to provide an air charge and/or to mix oxidized treated water with supply water, consistent with embodiments of the present disclosure.

FIG. 5A is a cross-sectional view of the venturi taken along line 5A-5A in FIG. 5.

FIGS. 6A-6E are cross sectional views of an oxidant control valve that provides both an oxidant charge and an air charge to the supply water, consistent with a further embodiment of the present disclosure, in different positions for different operating cycles.

FIGS. 7A-7E are schematic views of a water treatment system configured to provide an oxidant charge and an air charge to the treatment tank, consistent with further embodiments of the present disclosure, illustrating water and air flow for different operating cycles.

### DETAILED DESCRIPTION

A control valve system that allows treated water to return to the supply water, consistent with embodiments of the present disclosure, may be used with a water treatment system that provides oxidant treatment to control oxidation and flow of water in accordance with various operating cycles. The control valve system causes treated water to flow from the outlet to the inlet of the control valve to provide treated water to an oxidant device to facilitate water treatment. The control valve system may also be configured to prevent untreated water from being directed to the oxidant device, for example, during a regeneration cycle of the water treatment system. The control valve system may further be configured to provide oxidant during a rinse cycle, which advantageously prevents depleting or diluting oxidant levels in the system. The control valve system may also provide an air charge, for example, during an oxidant charge using a venturi that is also used to provide the oxidant charge or separately using a separate venturi.

Examples of water treatment systems include, but are not limited to, water softeners, acid neutralizers, iron/manganese removal systems, arsenic removal systems, other contaminant removal systems, and aeration systems. Water treatment systems may include one or more tanks or other devices that store or allow water to pass through as part of a treatment process. The water treatment systems may also include redundant water treatment tanks (e.g., redundant arsenic removal systems) or may include different water treatment tanks (e.g., an acid neutralizer and a water softener). Water treatment systems may also include water heaters or other devices that alter the temperature or other conditions of the water.

As used herein, “oxidant” means oxidizing agent and “oxidize” means to combine with oxygen. As used herein, “water oxidant device” or “oxidant device” refers to any product or mechanism that can oxidize water, for example, to facilitate oxidation, oxidize, sanitize or disinfect water, including, but not limited to, liquid chemical feed systems, solid chemical feed systems, oxygen generators, air ozone generators, water ozone generators, salt brine chlorine generators, venturis and air pumps. As used herein, “oxidized” means a substance that has been exposed to an oxidant. As used herein, “oxidant water” is water that is concentrated with an oxidant, for example, for the purpose of oxidizing iron, manganese, and/or hydrogen sulfide gas in water and/or to sanitize, disinfect or kill germs, bacteria, viruses, and/or fungi, which may help facilitate the removal of these contaminants from water supply systems.

As used herein, “fluid connection” refers to a connection between elements that allows fluid to flow between the elements and “fluidly couple” refers to coupling elements in a manner that allows a fluid connection between the elements. The terms “couple” and “connection” are not limited to a direct mechanical connection and may include an indirect mechanical connection that is made through other components or structures.

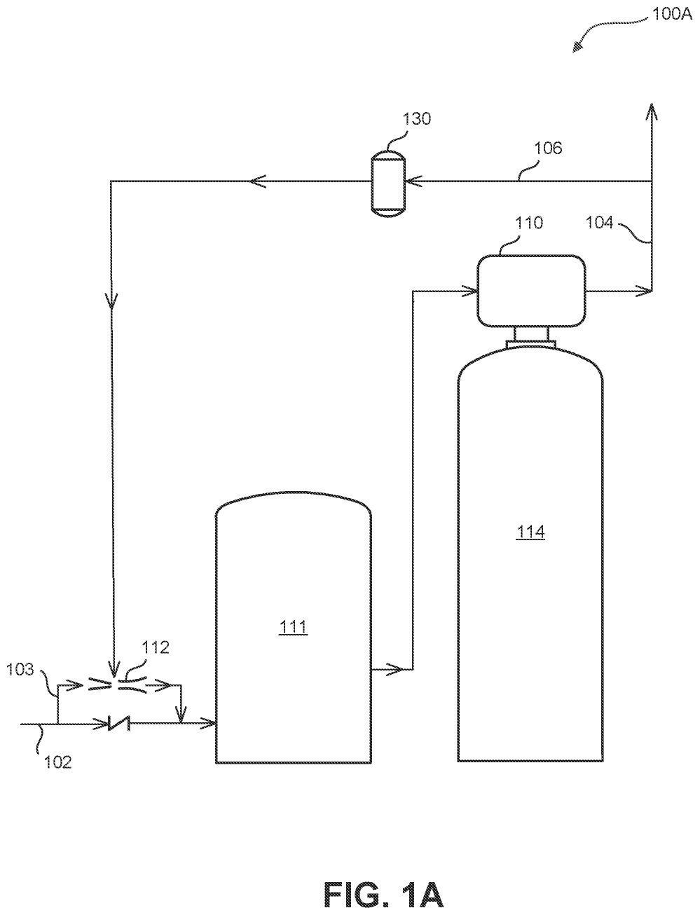

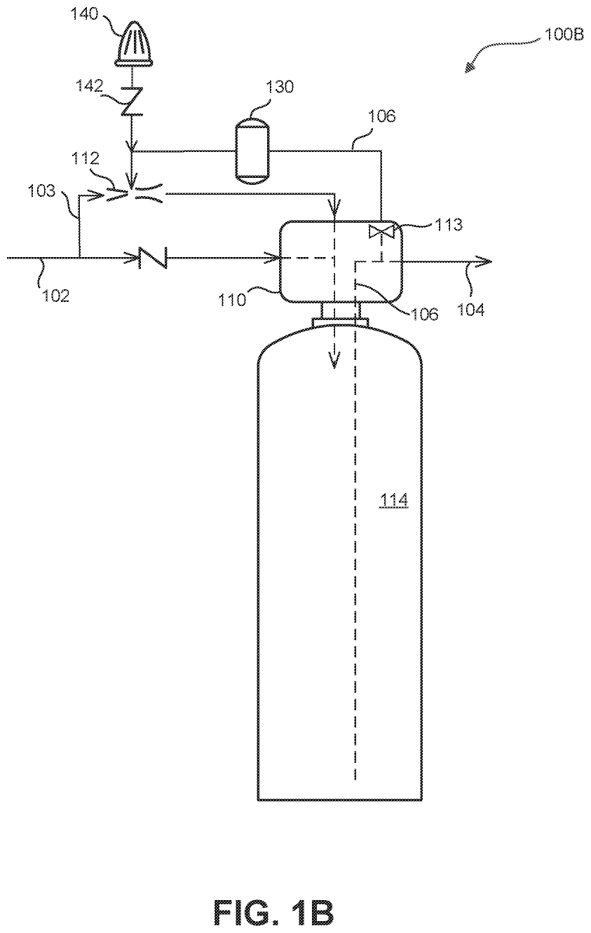

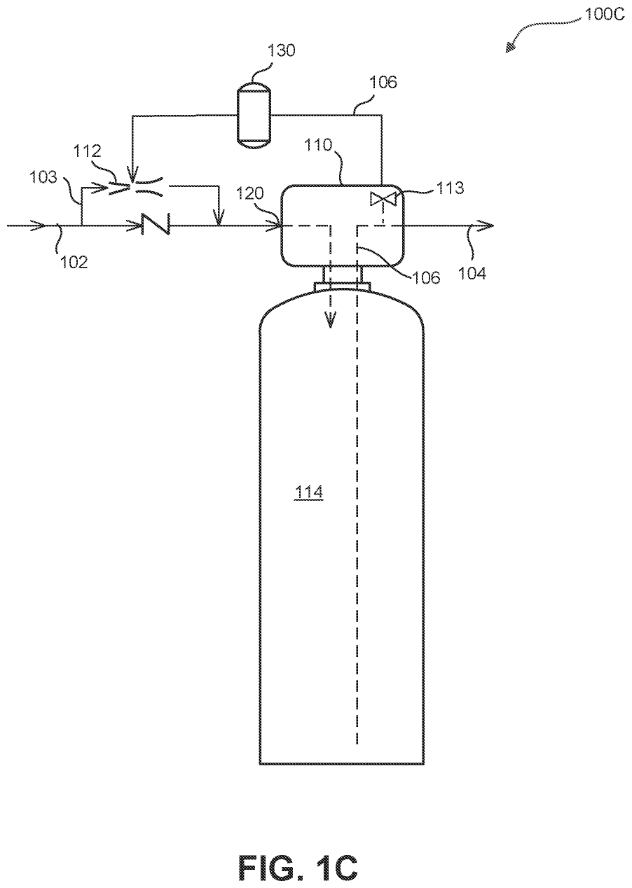

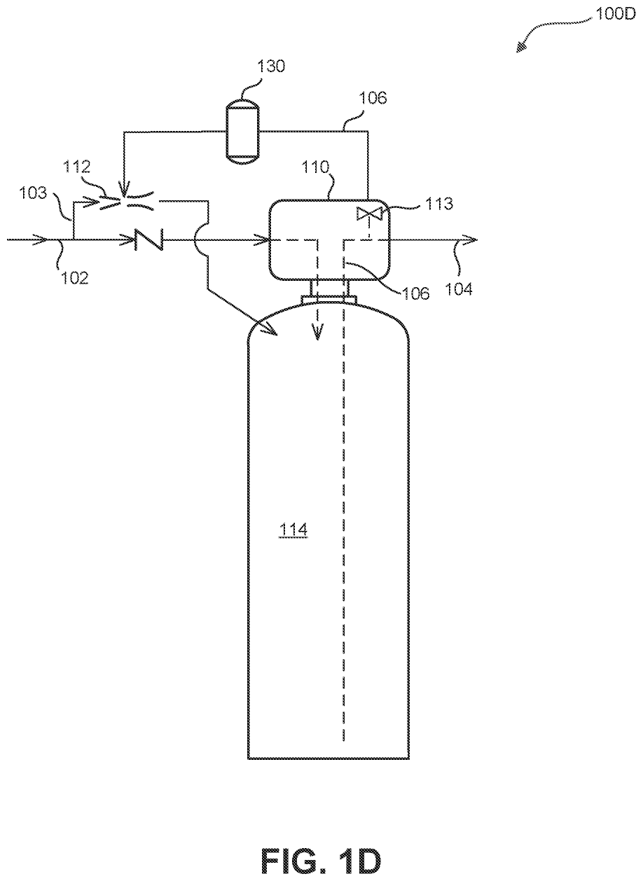

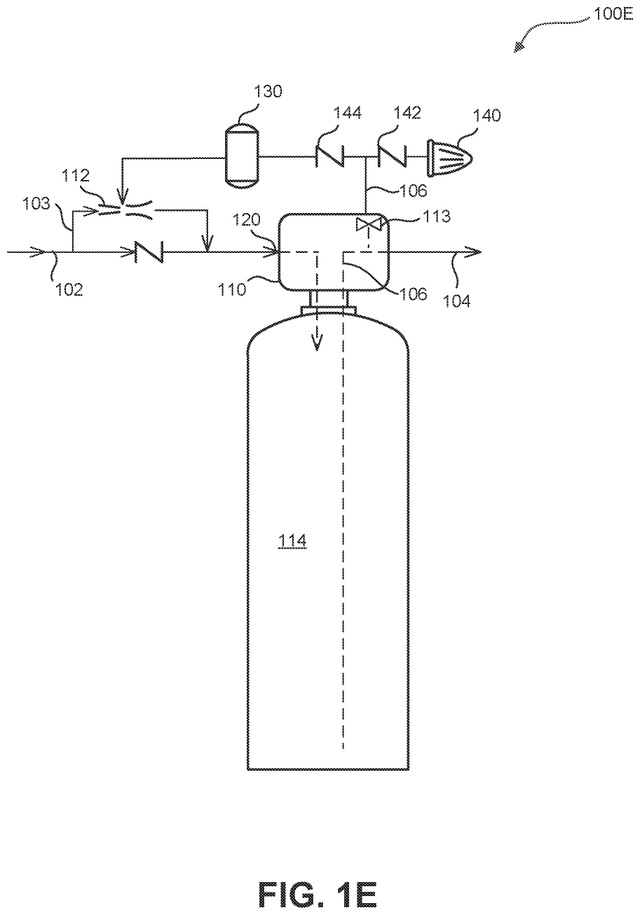

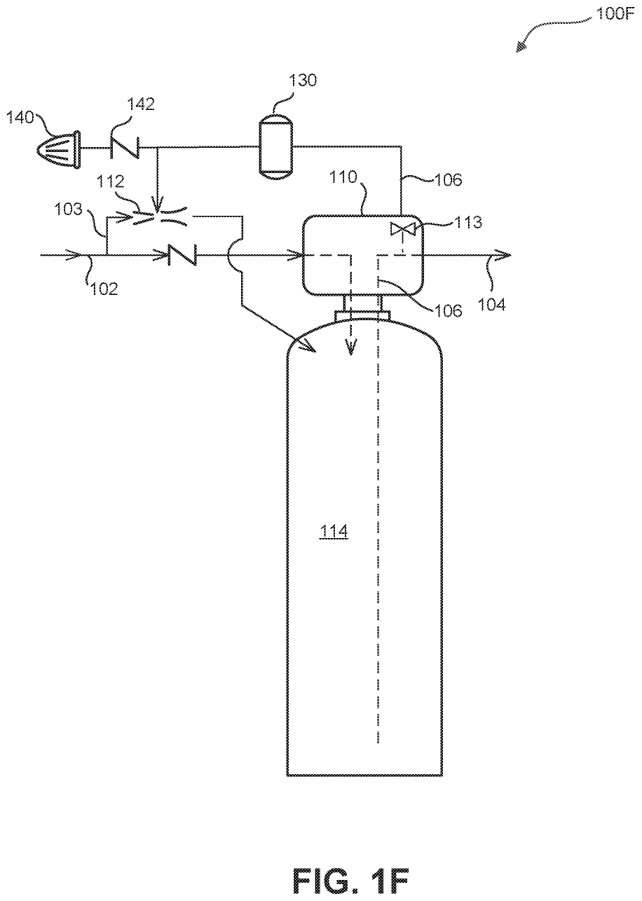

Referring to FIGS. 1A-1F, water treatment systems 100A-100F, consistent with various embodiments of the present disclosure, are described. As shown in FIG. 1A, a water treatment system 100A generally includes a control valve 110 coupled to a treatment tank 114 and an oxidant device 130 coupled between a delivery line 104 and a venturi 112. The venturi 112 may be part of a venturi aeration system, for example, used with a well pump and tank 111. Treated water 106 from the water treatment tank 114 may thus be directed via the delivery line 104 to the oxidant device 130 to allow the treated water to be oxidized. The oxidized treated water is then mixed in the venturi 112 with supply water 103 from a supply line 102 and is passed into the control valve 110. Although FIG. 1A is shown with the well pump and tank 111, a water treatment system, consistent with embodiments of the present disclosure, may be implemented without a well pump and tank and the venturi 112 may be coupled directly to or located in the control valve 110, coupled to a supply water inlet to the control valve 110, or coupled directly to the treatment tank 114, as will be described in greater detail below. In some embodiments, the same venturi may be used for the oxidant charge and the air charge, and in other embodiments, separate venturis may be used for the oxidant charge and the air charge.

In further embodiments, as shown in FIGS. 1B-1F, the water treatment systems 100B-100F may also be configured to prevent untreated water from being directed to the oxidant device 130 (e.g., during regeneration) while allowing the treated water 106 to be directed to the oxidant device 130. In each of these embodiments, the control valve 110 includes a treated water return valve 113 that directs treated water from the treatment tank 114 to the oxidant device 130 and prevents untreated water from being directed to the oxidant device 130, for example, during a regeneration cycle. The embodiments of FIGS. 1B, 1E and 1F are further configured to allow an air charge into the control valve 110 in addition to an oxidant charge.

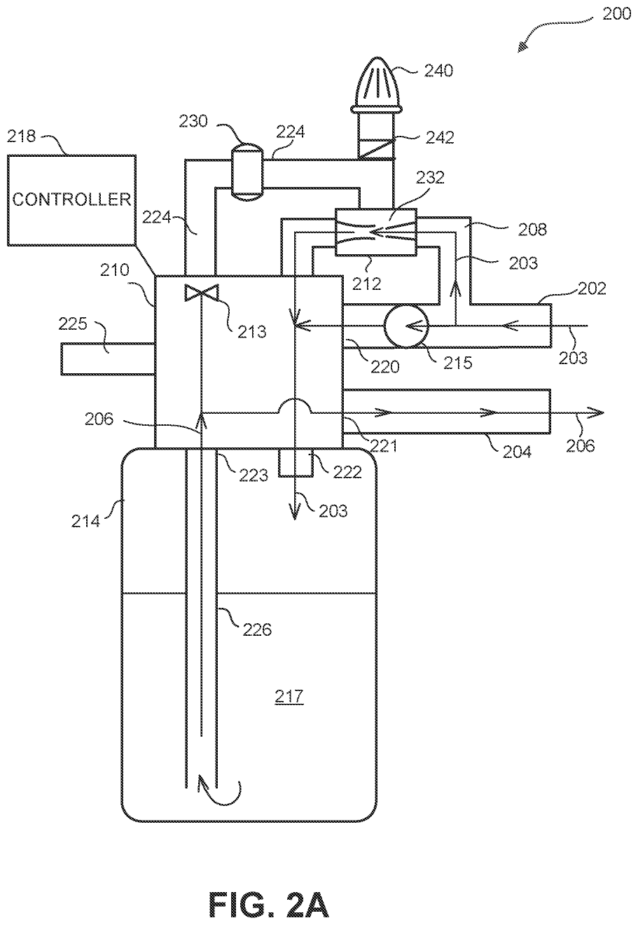

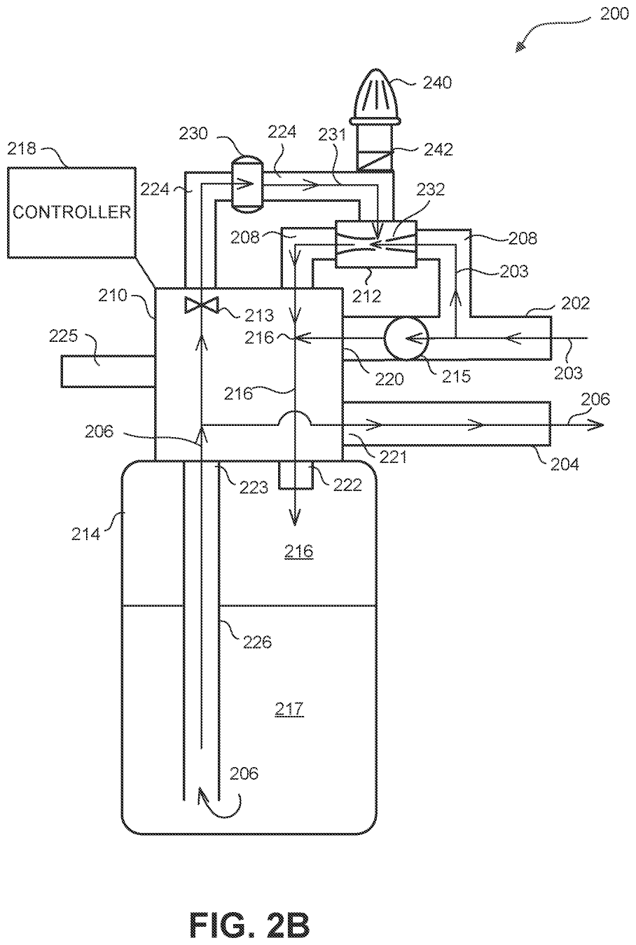

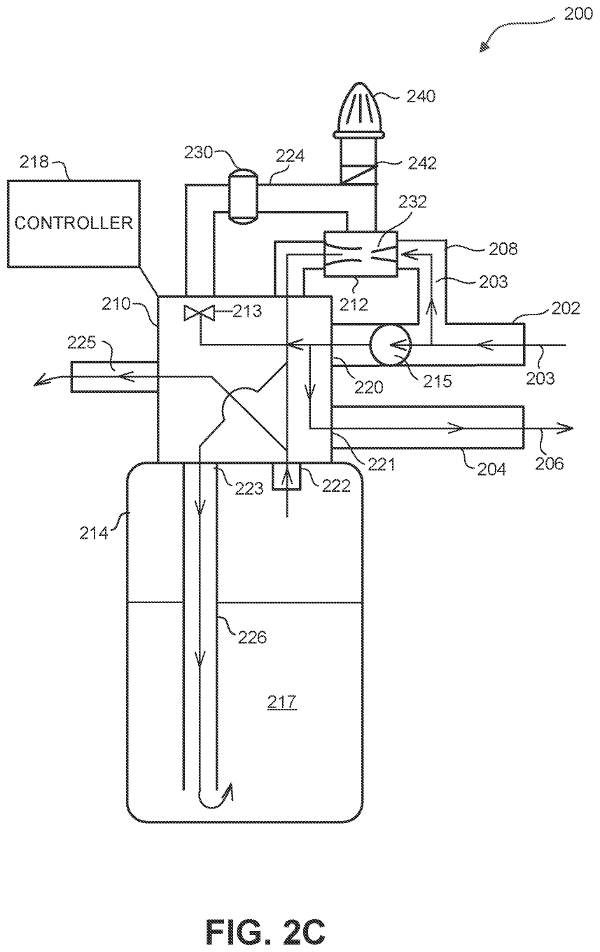

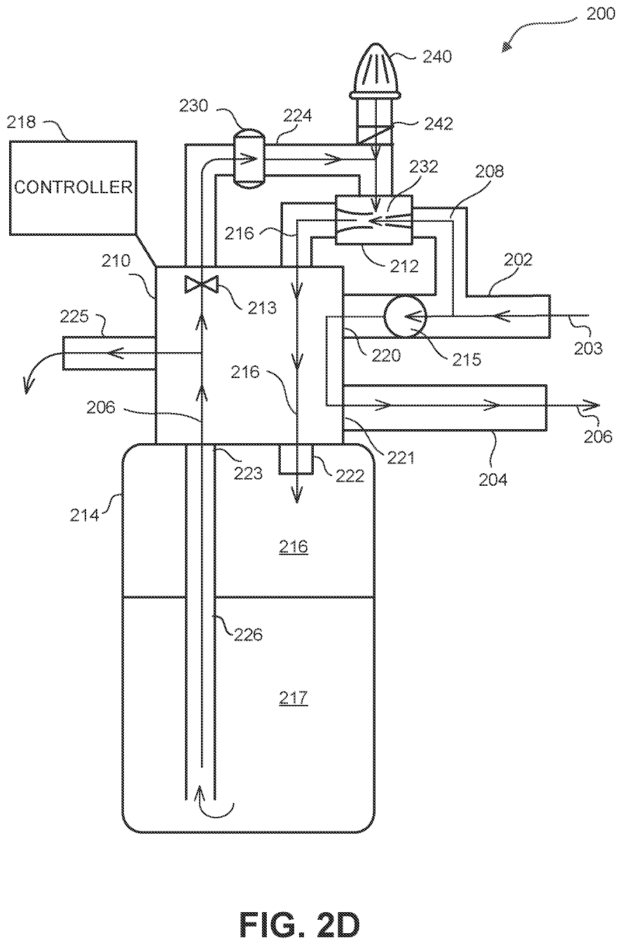

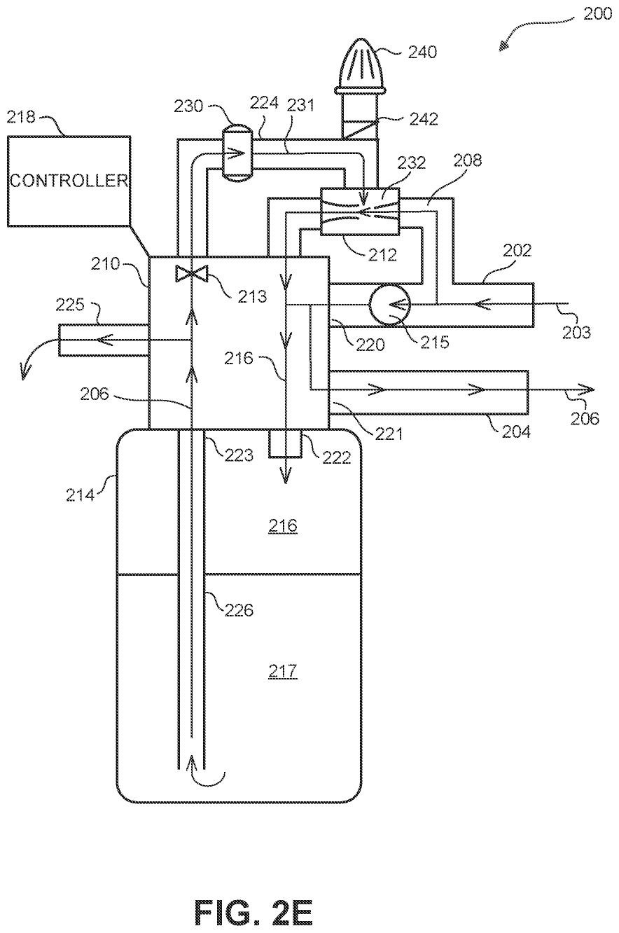

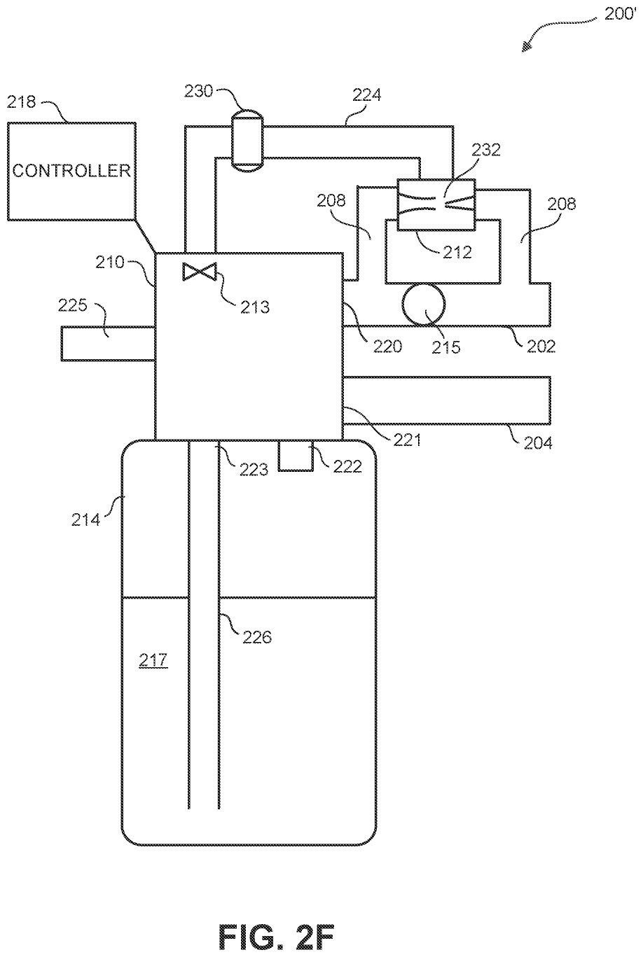

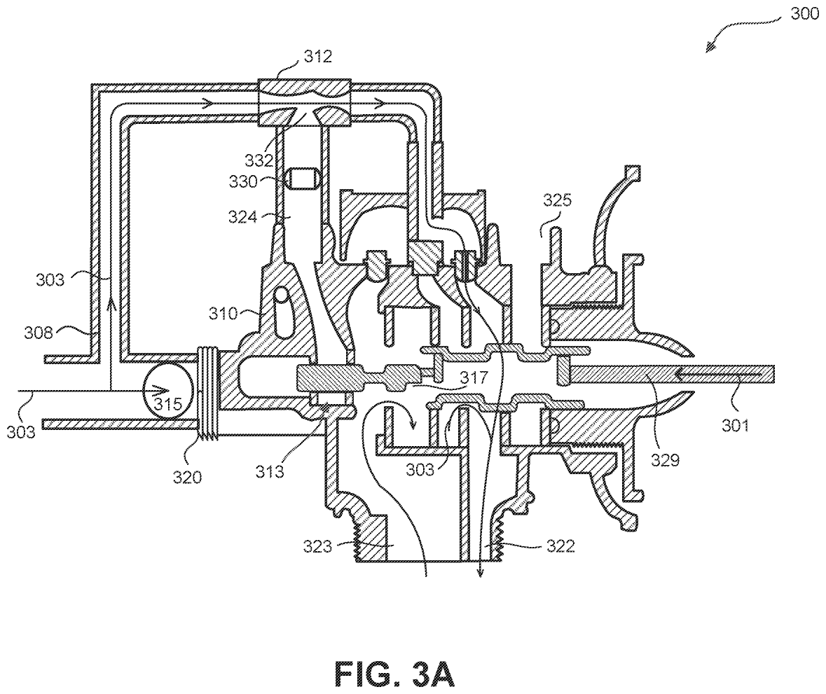

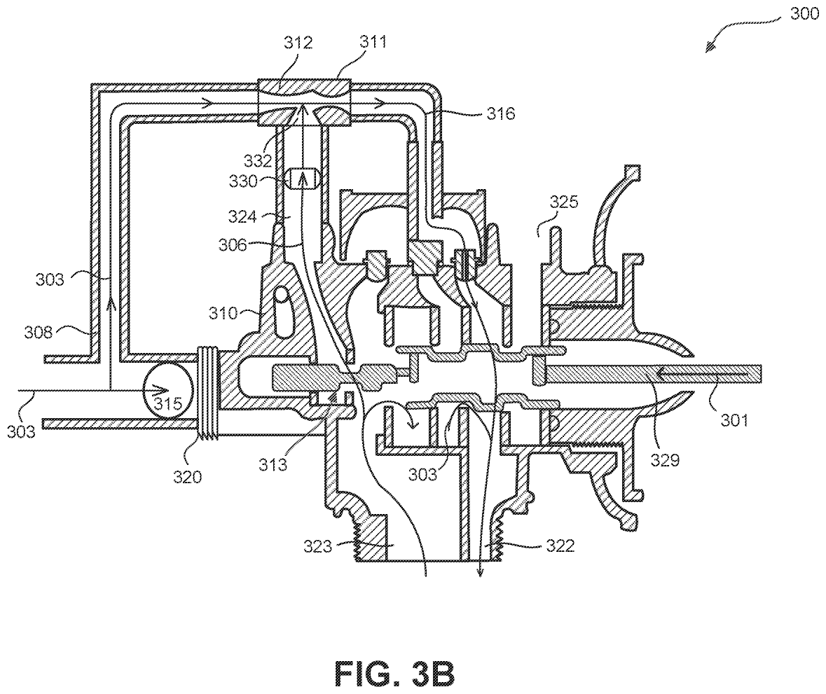

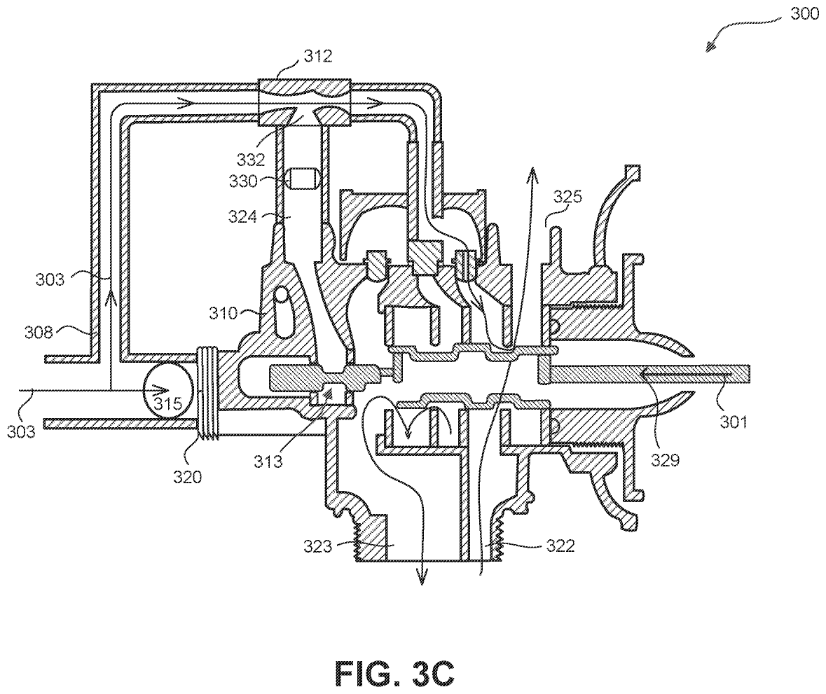

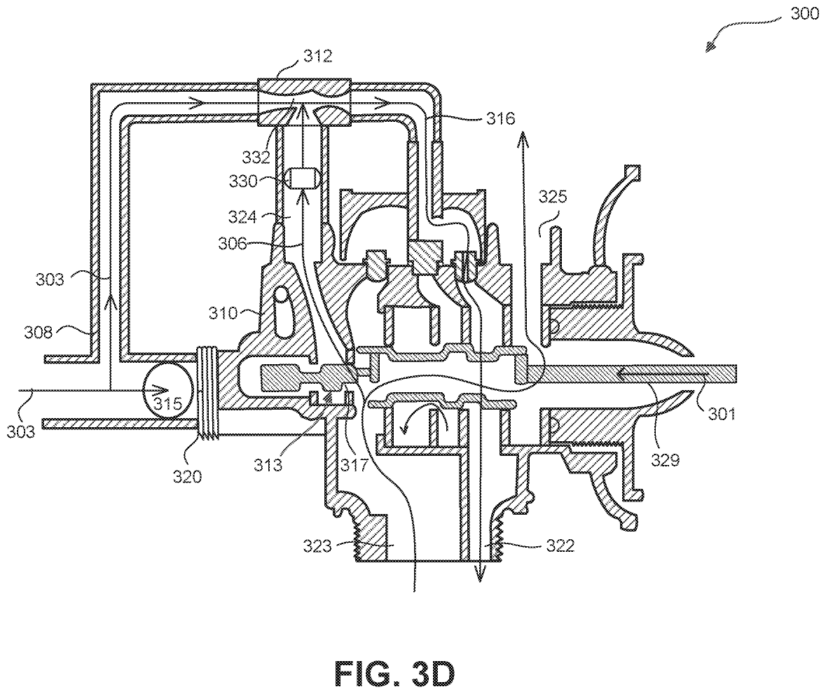

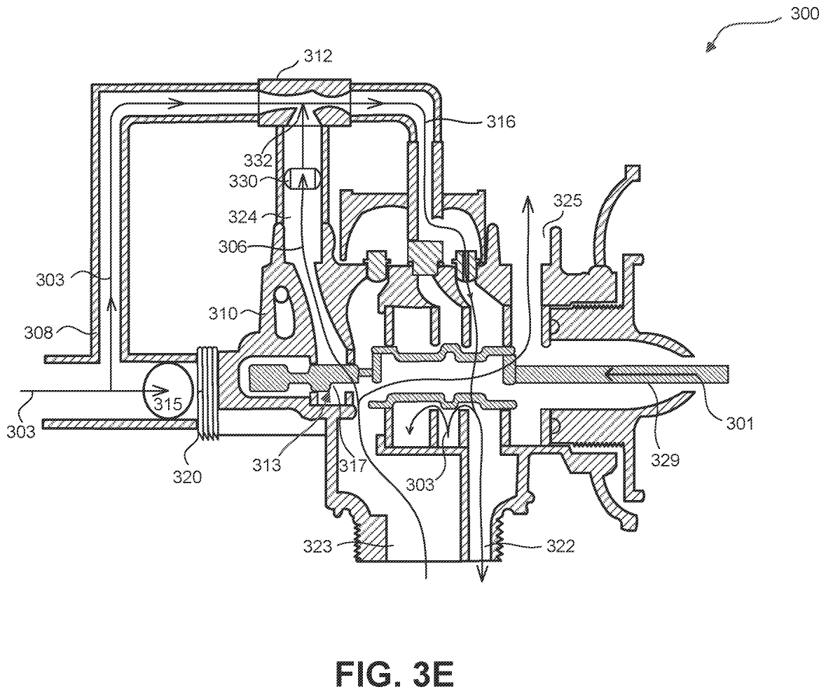

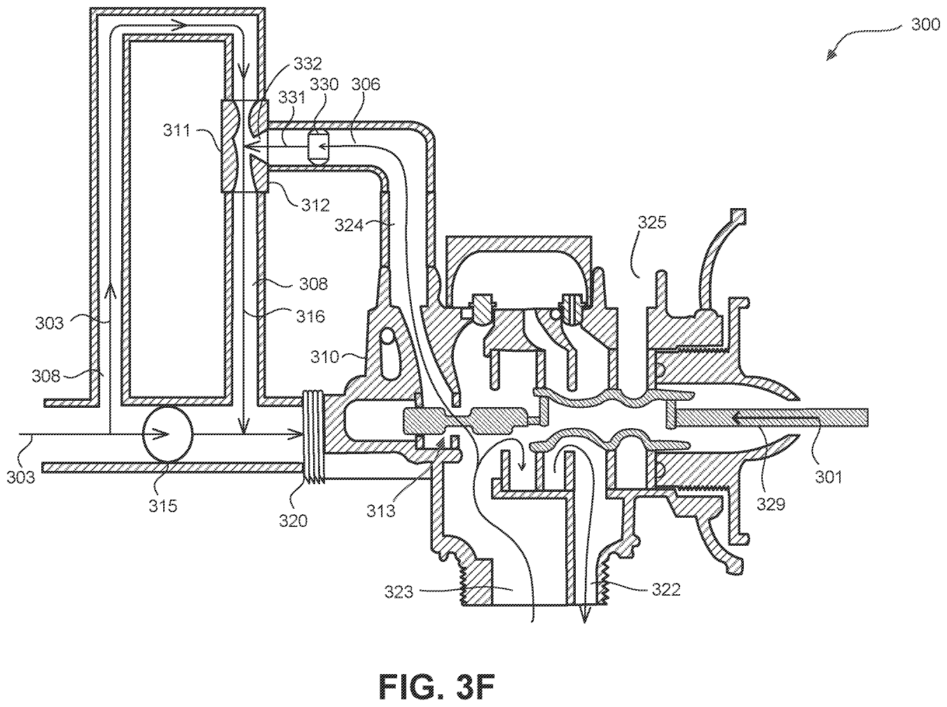

In the embodiment of the water treatment system 100B shown in FIG. 1B, the venturi 112 is fluidly coupled to (or integrated with) the control valve 110 and an air source 140 is fluidly coupled to the venturi 112 via a valve 142. This embodiment of the water treatment system 100B is thus configured to allow an air charge and an oxidant charge into the control valve 100 via the same venturi 112. This embodiment of the water treatment system 100B is described in greater detail in connection with FIGS. 2A-2E. In other embodiments, the water treatment system 100B may be used without providing an air charge and an embodiment of a control valve system that may be used without an air charge in this embodiment of the water treatment system 100B is described in greater detail in connection with FIGS. 3A-3E.

In the embodiment of the water treatment system 100C shown in FIG. 1C, the venturi 112 is fluidly coupled to a water supply inlet 120 to the control valve 110 to allow an oxidant charge into the supply water 102 just before entering the control valve 110. This embodiment of the water treatment system 100C is described in greater detail in connection with FIG. 2F and an embodiment of a control valve system that may be used in this embodiment of water treatment system 100B is described in greater detail in connection with FIG. 3F.

In the embodiment of the water treatment system 100D shown in FIG. 1D, the venturi 112 is fluidly coupled to the treatment tank 114 to allow an oxidant charge directly into the treatment tank 114. This embodiment of the water treatment system 100D is similar to the embodiment shown in FIG. 1C but with the venturi 112 fluidly coupled to the tank 114 instead of the water supply inlet 120. This embodiment of the water treatment system 100D is similar to that described in greater detail in connection with FIG. 2F and an embodiment of a control valve that may be used in this embodiment of the water treatment system 100D is similar to that described in greater detail in connection with FIG. 3F.

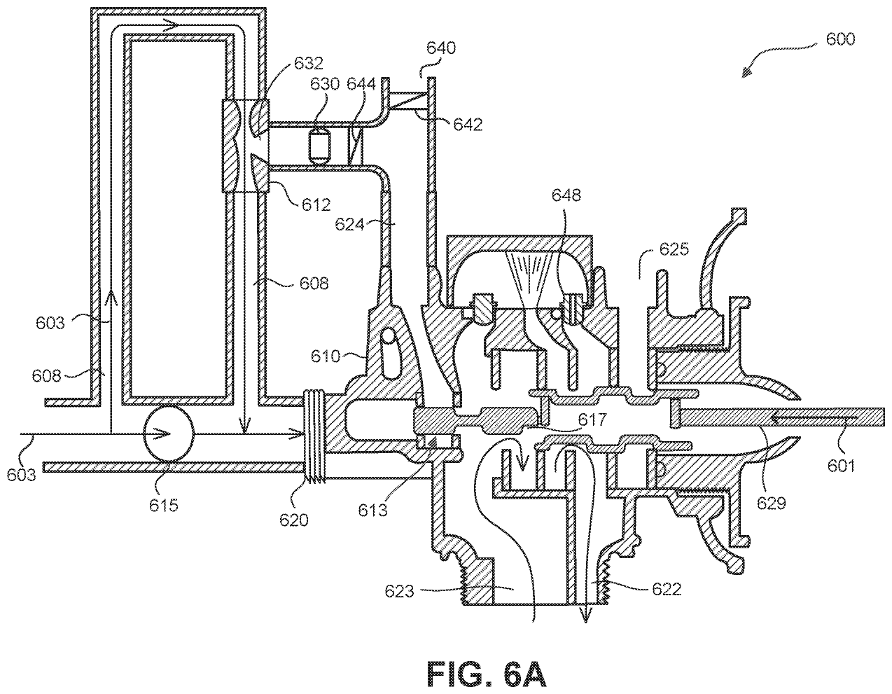

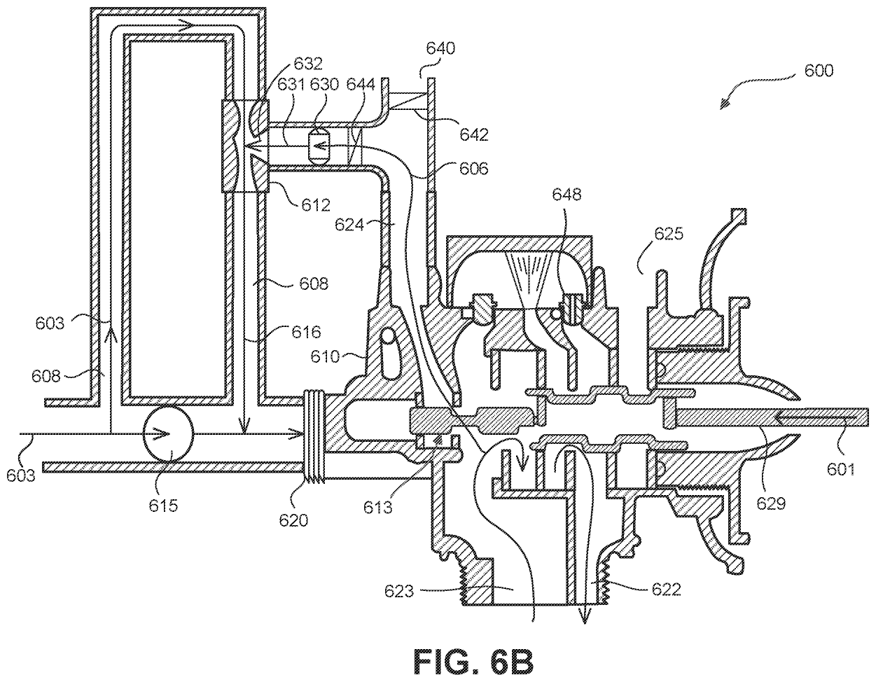

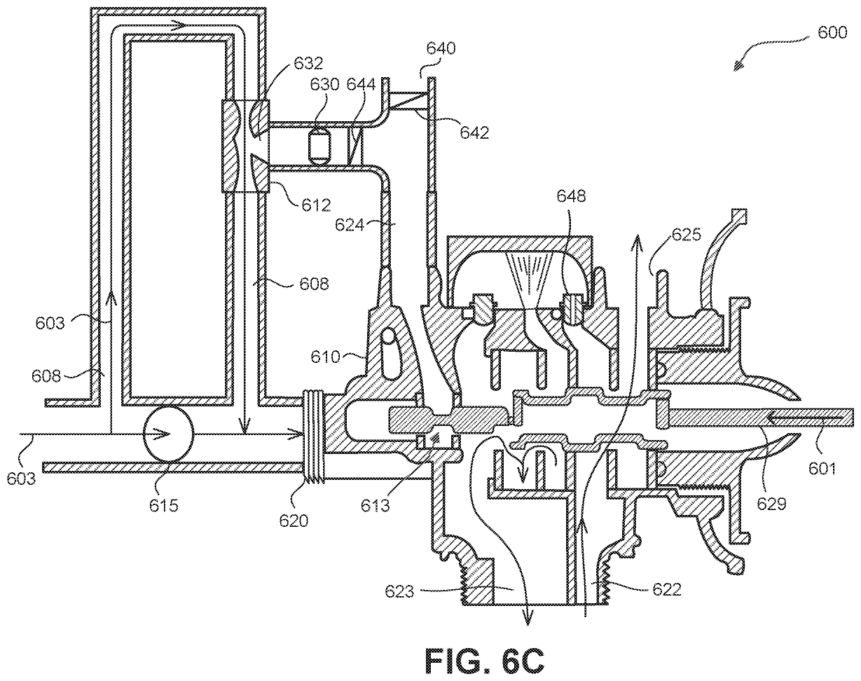

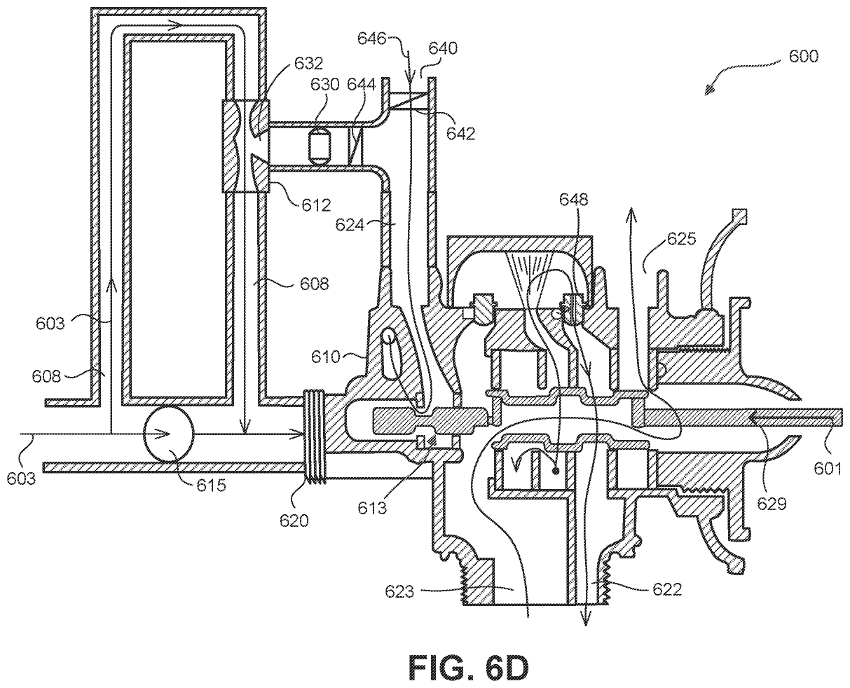

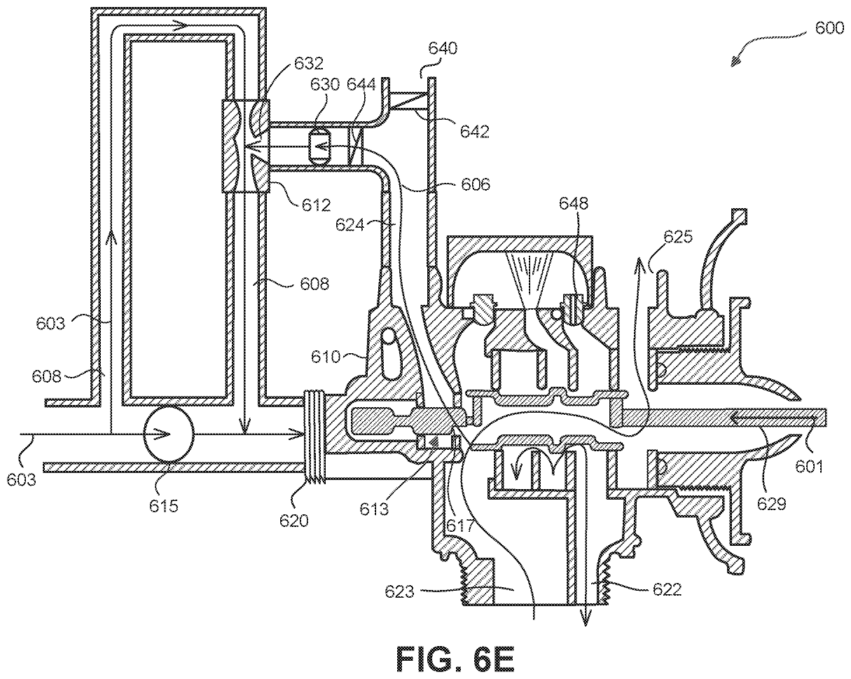

In the embodiment of the water treatment system 100E shown in FIG. 1E, the venturi 112 is fluidly coupled to a water supply inlet 120, the air source 140 is fluidly coupled to the control valve 110 via the valve 142, and the oxidant device 130 is fluidly coupled to the control valve 110 via the valve 144. This embodiment of the water treatment system 100E is thus configured to allow both an oxidant charge into the supply water and configured to allow an air charge into the oxidant control valve 110. An embodiment of a control valve system that may be used in this embodiment of water treatment system 100E may include a separate internal venturi (not shown) to draw the air charge from the air inlet 140 and is described in greater detail in connection with FIGS. 6A-6F.

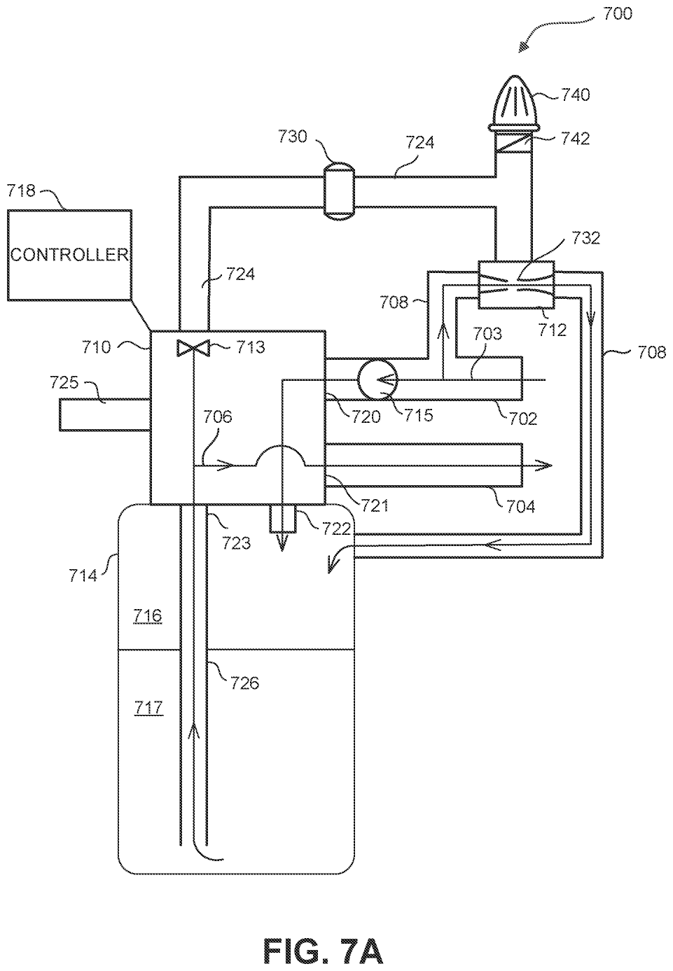

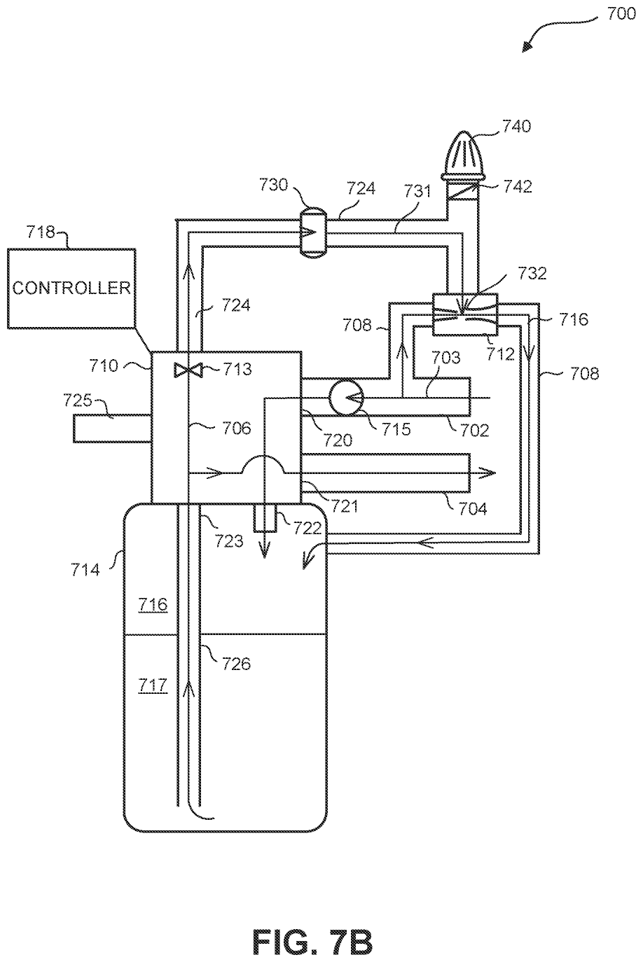

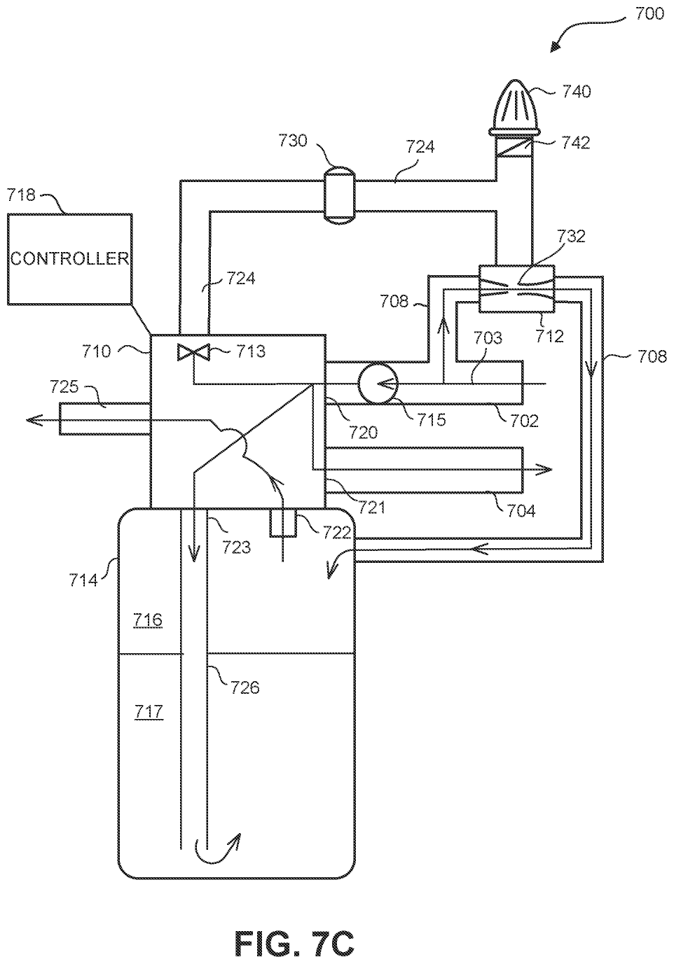

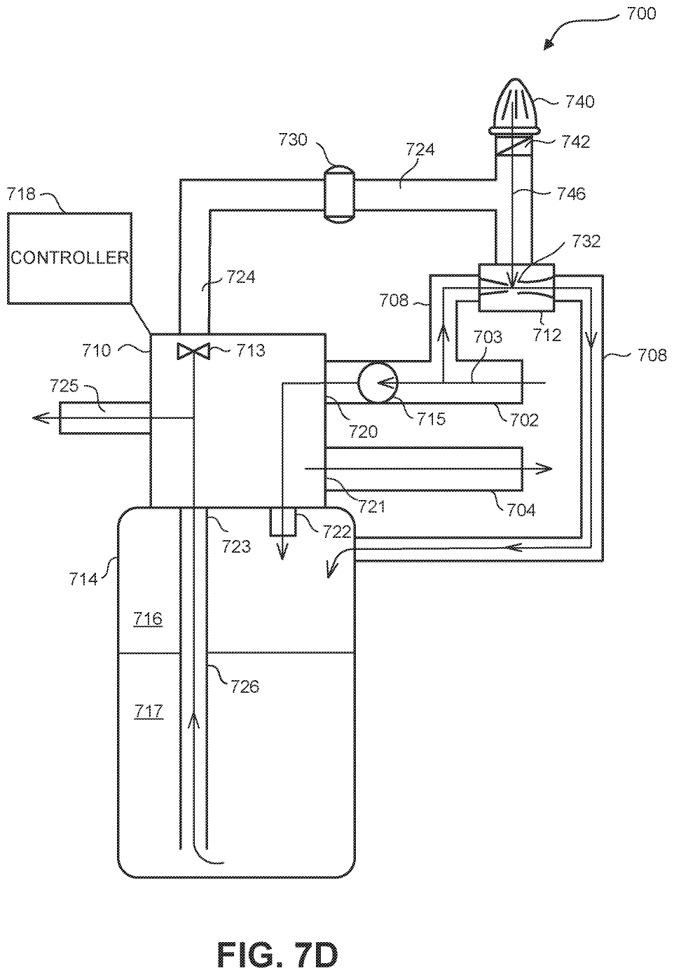

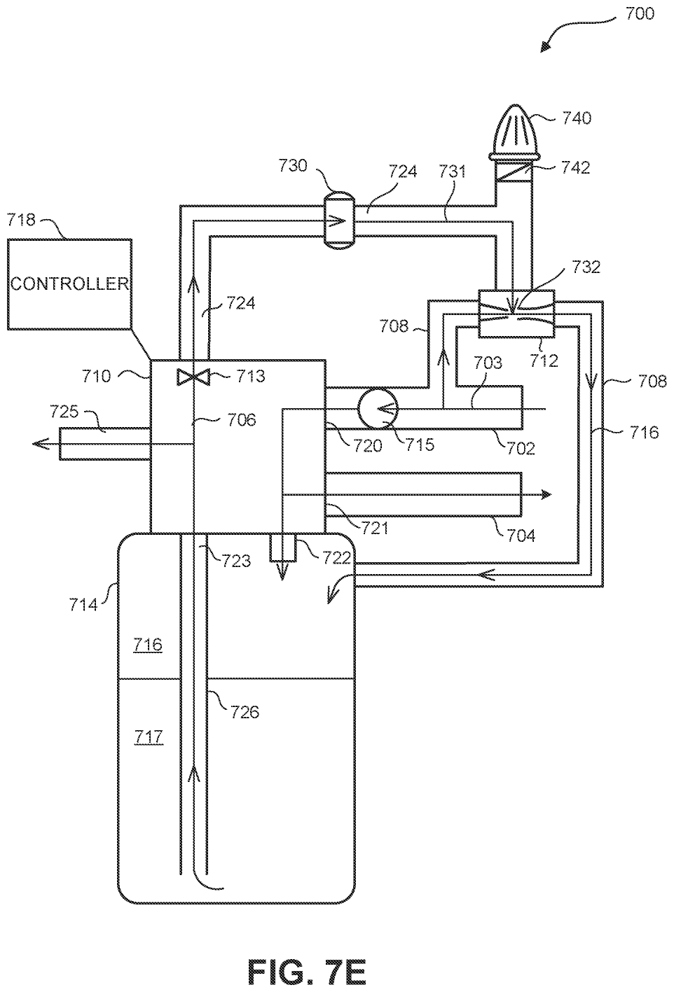

In the embodiment of the water treatment system 100F shown in FIG. 1F, the venturi 112 is coupled to the treatment tank 114, the oxidant device 130 is coupled to the venturi 112, and the air source 140 is coupled to the venturi 112 via a valve 142. This embodiment of the water treatment system 100F is thus configured to allow an oxidant charge into the tank 114 and configured to allow an air charge into the tank 114 via the same venturi 112. This embodiment of water treatment system 100F is described in greater detail in connection with FIGS. 7A-7E.

Referring to FIGS. 2A-2E, a water treatment system 200, consistent with an embodiment, includes an oxidant control valve 210 (also referred to as a valve assembly) fluidly coupled to a water treatment tank 214, a water supply line 202, and a water delivery line 204. The oxidant control valve 210 includes a supply water inlet passage 220, a service water outlet passage 221, first and second tank passages 222, 223, and a drain outlet passage 225. The supply water inlet passage 220 may be fluidly coupled to the supply line 202 and the service water outlet passage 221 may be fluidly coupled to the delivery line 204. The first and second tank passages 222, 223 are coupled to the water treatment tank 214 for passing water in to and out of the tank 214. In one embodiment, the second tank passage 223 is coupled to a conduit 226 that extends into the filter media 217 proximate the bottom region of the water treatment tank 214. The drain outlet passage 225 may be coupled to a drain for directing water from the tank 214 to the drain.

The oxidant control valve 210 also includes a pressure opening device 215 fluidly coupled to the supply water inlet passage 220, a parallel fluid passage 208 in parallel with the pressure opening device 215, a venturi 212 fluidly coupled to the parallel fluid passage 208, a treated water return passage 224 fluidly coupled to a venturi throat area 232 of the venturi 212, and an oxidant device 230 fluidly coupled to the treated water return passage 224. A treated water return valve 213 in the control valve 210 is coupled to the treated water return passage 224 to control the flow of water to the oxidant device 230. An air inlet 240 and a one-way valve 242 may also be fluidly coupled with the venturi 212 to provide an air charge.

Thus, the oxidant control valve 210 controls the flow of supply water 203, oxidant water 231, oxidized water 216, and treated oxidized water 206 in to and out of the water treatment tank 214, while the oxidant device 230 provides oxidation, as shown in FIG. 2B and described in greater detail below. The water treatment tank 214 may contain filter media 217 for filtering the oxidized water, whereby the oxidized water 216, when in contact with the filter media 217, can oxidize the filter media 217 and be treated by the filter media 217 such that the oxidized water 216 becomes treated oxidized water 206.

To provide water treatment, the water treatment system 200 directs supply water 203 from the supply line 202 through the water treatment tank 214 to the delivery line 204. The supply line 202 may supply water from a water source such as a well or city water supply. The delivery line 204 may provide water to a service water system in a building, such as a residential home. The water treatment system 200 may be coupled, for example, to a residential water supply system at the point of entry. The water treatment system 200 may also be configured for use in a commercial water supply system.

The water treatment system 200 makes oxidized water 216 by utilizing the pressure opening device 215 to force part of the water flowing in the supply line 202 to flow through the parallel fluid passage 208 around the pressure opening device 215 and through the venturi 212, thereby inducing a low-pressure zone in the venturi throat area 232 of the venturi 212. As a result of the low-pressure zone, at least part of the treated oxidized water 206 is directed from the second tank passage 223 to pass through the treated water return valve 213, the treated water return passage 224 and the oxidant device 230 to create oxidant water 231 in the treated water return passage 224. The oxidant water 231 is drawn into the throat area 232 of the venturi 212 and mixed with the supply water 203 as it passes out of the parallel fluid passage 208 through the venturi 212 and into the venturi throat area 232. The oxidant water 231 then enters the oxidant control valve 210 and further mixes with supply water 203 as it passes out of the pressure opening device 215 and enters the control valve 210 to become oxidized water 216.

The oxidized water 216 is then allowed to enter the water treatment tank 214 and may oxidize the filter media 217. The filter media 217 filters the oxidized water 216 as it passes through filter media 217 to become treated oxidized water 206. In one example, iron, manganese and hydrogen sulfide gas dissolved in the supply water 203 is oxidized when exposed to the oxidant water 231 and becomes a solid precipitate that can be trapped in the filter media 217. The filter media 217 may be a form of manganese dioxide media, which can be charged with oxygen and help with oxidation or any type of filter media capable of trapping the contaminants to be removed. The oxidant control valve 210 may be used with various types and configurations of water treatment systems including arsenic 3 oxidation.

The oxidant control valve 210 may also include a valve cycle actuator (shown in FIGS. 3A-3E) that provides fluid connections between the passages 208, 220-225 based on different positions of the valve cycle actuator. The control valve 210 controls the flow of water between the passages 208, 220-225 and in to and out of the water treatment tank 214, for example, according to the various water treatment cycles or operations, as illustrated in each of FIGS. 2A-2E. In a water softener or filter, for example, a control valve assembly may provide different positions of a regeneration cycle allowing water to flow according to different water softener or filter treatment cycles. For example, FIG. 2A illustrates the flow with the control valve 210 in a service position, FIG. 2B, illustrates the flow with the control valve 210 in an oxidant charge during service position, FIG. 2C illustrates the flow with the control valve 210 in a backwash position, FIG. 2D illustrates the flow with the control valve 210 in an oxidant charge and air charge during brine draw position, and FIG. 2E illustrates the flow with the control valve 210 in an oxidant charge during rinse position.

The oxidant control valve 210 may also open and close the treated water return valve 213 by moving the valve cycle actuator from the service position to the oxidant charge during service position and back to the service position to control the amount of oxidant used in proportion to oxidant demand and water flow during service. The oxidant control valve 210 may also keep the treated water return valve 213 open during service to allow oxidant supply on demand any time there is water flow during service. In other embodiments, the oxidant control valve 210 may keep the treated water return valve 213 closed during service to not supply oxidant during service and only open the water return valve 213 during a service cycle with oxidant charge and/or the rinse regeneration cycle with oxidant charge.

The oxidant control valve 210 may include user controls on a side thereof to allow the user to control valve functionality such as when certain treatment cycles or operations occur (e.g., based on a time of day or number of days or number of gallons used). A controller 218 may also be coupled to the control valve 210, providing a control valve system, to control operation of the control valve 210 and initiation of the cycles of operation, for example, according to a programmed schedule. Other types of controls may also be provided.

During a service cycle without oxidant charge, as shown in FIG. 2A, the water treatment system 200 is in “service”, treating water and directing the treated water to the service water system with the treated water return valve 213 closed. In this embodiment, the oxidant control valve 210 allows supply water 203 to flow from the supply line 202 into the supply water inlet passage 220 through the pressure opening device 215 and into the oxidant control valve 210 and allows supply water 203 to flow through the parallel fluid passage 208 around the pressure opening device 215 through the venturi 212 and into the oxidant control valve 210 rejoining the supply water 203 from the pressure opening device 215. The oxidant control valve 210 then allows the supply water 203 to flow into the first tank passage 222 to the top region of the tank 214 such that the supply water 203 passes through the filter media 217 and/or the tank 214 where it becomes treated water 206. The treated water 206 may be drawn from the bottom region of the tank through the conduit 226 coupled to the second tank passage 223 and directed from the second tank passage 223 to the service water outlet passage 221 and the delivery line 204.

During an oxidant charge during service cycle, as shown in FIG. 2B, the water treatment system 200 is in “service”, treating water and directing the treated water to the service water system, similar to FIG. 2A, except the treated water return valve 213 is open. In this embodiment, when supply water 203 flows through the venturi 212, the flow creates a low-pressure zone around the venturi throat area 232. This low-pressure zone causes treated oxidized water 206 from the area near the second tank passage 223 and service water outlet passage 221 to flow through the treated water return valve 213 into the treated water return passage 224 and through the oxidant device 230 to create oxidant water 231. The oxidant water 231 is then allowed to enter the venturi throat area 232 of the venturi 212 to mix with the supply water 203 from the parallel fluid passage 208 as it enters the venturi throat area 232 of the venturi 212. This blend of supply water 203 and oxidant water 231 from the venturi 212 is then allowed to mix with the supply water 203 from the pressure opening device 215 as they both enter the oxidant control valve 210 to make oxidized water 216. This oxidized water 216 then is allowed to flow out of the oxidant control valve 210 through the first tank passage 222 and into the water treatment tank 214 where the filter media 217 is oxidized by the oxidized water 216 as it passes through the filter media 217 and the oxidized water 216 becomes treated oxidized water 206. The treated oxidized water 206 may be drawn from the bottom region of the tank 214 through the conduit 226 coupled to the second tank passage 223 and directed from the second tank passage 223 to the service water outlet passage 221 and the delivery line 204. Part of the treated oxidized water 206 is also allowed to flow through the treated water return valve 213, into the treated water return passage 224 and through the oxidant device 230 to create oxidant water 231 and start the oxidant charge during service cycle process over again.

During a backwash cycle, as shown in FIG. 2C, the oxidant control valve 210 allows supply water 203 to flow into the supply water inlet passage 220 through the pressure opening device 215 and into the oxidant control valve 210 to the service water outlet passage 221, the treated water return valve 213, and the second tank passage 223. The treated water return valve 213 is closed to prevent this untreated supply water from flowing into the treated water return passage 224 and through the oxidant device 230. The oxidant control valve 210 also allows the supply water 203 to flow through a parallel fluid passage 208 around the pressure opening device 215 through the venturi 212 and into the oxidant control valve 210, rejoining the supply water 203 from the pressure opening device 215. This water then flows through the second tank passage 223 and through the conduit 226 into the bottom region of the water treatment tank 214 and is directed up through the filter media 217 into the first tank passage 222 and out the drain outlet passage 225.

During an oxidant regeneration, as shown in FIG. 2D, the water treatment system 200 is in “brine draw” with the treated water return valve 213 open. In this embodiment, the oxidant control valve 210 allows supply water 203 to flow from the supply line 202 into supply water inlet passage 220, into the parallel fluid passage 208 around the pressure opening device 215 and into the venturi 212, causing a low-pressure zone at the venturi throat area 232. This low pressure causes air to enter the air inlet 240 through the one-way valve 242 into the venturi throat area 232 and causes treated oxidized water 206 from the second tank passage 223 to flow through the treated water return valve 213 into the treated water return passage 224 and through the oxidant device 230 to create oxidant water 231. The oxidant water 231 is then allowed to enter the venturi throat area 232 of the venturi 212 to mix with air and the supply water 203 from the parallel fluid passage 208 as it enters the venturi throat area 232 of the venturi 212. This blend of air, supply water 203 and oxidant water 231 from the venturi 212 is then allowed to flow out of the oxidant control valve 210 through the first tank passage 222 and into the water treatment tank 214 where the filter media 217 is oxidized by the oxidized water 216 as it passes through the filter media 217 and the oxidized water 216 becomes treated oxidized water 206. At least some of the treated oxidized water 206 is allowed to recirculate back to the venturi throat area 232 to create oxidized water 216, which flows out of the venturi 212 through the oxidant control valve 210 and into the filter media 217, where the filter media 217 is charged with oxygen as the oxidized water 216 passes through the filter media 217.

The treated water may be drawn from the bottom region of the tank through the conduit 226 coupled to the second tank passage 223 where part of the water goes to the drain outlet passage 225 and part is recirculated back to the venturi throat area 232 by passing through the treated water return valve 213 and through the treated water return passage 224. This recirculated water is then re-oxidized through the oxidant device 230 and passes into the venturi throat area 232 and out the venturi 212, starting the process over again. During the oxidant charge cycle, the oxidant control valve 210 may also direct untreated water from the supply water inlet passage 220 to the service water outlet passage 221.

During a rinse regeneration with oxidant charge, as shown in FIG. 2E, the oxidant control valve 210 allows supply water 203 to flow from the supply line 202 into the supply water inlet passage 220 through the pressure opening device 215 and into the oxidant control valve 210. The oxidant control valve 210 also allows supply water 203 to flow through the parallel fluid passage 208 around the pressure opening device 215 through the venturi 212, thereby creating a low-pressure zone at the venturi throat area 232. This low pressure causes treated oxidized water 206 from the second tank passage 223 to flow through the treated water return valve 213 into the treated water return passage 224 and through the oxidant device 230 to create oxidant water 231. The oxidant water 231 is then allowed to enter the venturi throat area 232 of the venturi 212 to mix with the supply water 203 from the parallel fluid passage 208 as it enters the venturi throat area 232 of the venturi 212. This blend of supply water 203 and oxidant water 231 from the venturi 212 is then allowed to mix with the supply water 203 from the pressure opening device 215 as they both enter the oxidant control valve 210 to make oxidized water 216. This oxidized water 216 then is allowed to flow out of the oxidant control valve 210 through the first tank passage 222 and into the water treatment tank 214 where the filter media 217 is oxidized by the oxidized water 216 as it passes through the filter media 217 and the oxidized water 216 becomes treated oxidized water 206.

The treated oxidized water 206 may be drawn from the bottom region of the tank 214 through the conduit 226 coupled to the second tank passage 223 where part of the treated oxidized water 206 goes to the drain outlet passage 225 to complete rinse regeneration and part is recirculated back through the treated water return valve 213 for oxidant charge during rinse regeneration. This allows oxidant to be provided during a rinse cycle, which advantageously prevents depleting or diluting the oxidant level in the system during the rinse cycle. During the rinse with oxidant charge cycle, the oxidant control valve 210 may also direct untreated water from the supply water inlet passage 220 to the service water outlet passage 221.

FIG. 2F illustrates a further embodiment of a water treatment system 200′, consistent with the present disclosure. This embodiment of the water treatment system 200′ is similar to that shown in FIGS. 2A-2E but with the fluid passage 208 including the venturi 212 being coupled to the supply water inlet passage 220 instead of directly to the control valve 210. This embodiment of the water treatment system 200′ may operate with the same cycles described above and illustrated in FIGS. 2A-2E.

Referring to FIGS. 3A-3E, an embodiment of an oxidant control valve 300 (also referred to as a control valve assembly) may be based on a WS Series control valve available from Clack Corporation with some modifications to allow oxidant charge during service, oxidant charge during brine draw, and oxidant charge during rinse cycles. Other implementations of an oxidant control valve are also contemplated. The oxidant control valve 300 may be used in the water treatment system 200 described above but without the air charge, and FIGS. 3A-3E show the oxidant control valve 300 in various positions corresponding to the cycles shown in respective FIGS. 2A-2E but without the air charge.

The control valve 300 includes a valve body 310, a supply water inlet passage 320, a service water outlet passage (not shown), first and second tank passages 322, 323, a treated water return passage 324, a parallel fluid passage 308, and a drain passage 325. The parallel fluid passage 308 is fluidly coupled to the treated water return passage 324 to allow treated oxidized water 306 to return to the supply water 303 while in service, as shown in FIG. 3B. The supply water inlet passage 320 and any service water outlet passage may be coupled to a water supply and delivery system. According to this embodiment, a valve cycle actuator 329 moves within the valve body 310 to provide a fluid connection between the passages 308, 320-325. The valve cycle actuator 329 may include a piston rod that moves through various positions for each of the different cycles, as will be described in greater detail below.

The control valve 300 includes, for example, a pressure opening device 315, such as a check valve, located in the supply water inlet passage 320, an oxidant device 330 located in the treated water return passage 324 and a venturi 312 located in the parallel fluid passage 308. The pressure opening device 315 causes at least a portion of the supply water 303 to flow into the parallel fluid passage 308 and through the venturi 312. A treated water return valve 313 controls the flow of treated water from the second tank passage 323 to the treated water return passage 324. In an embodiment, a brine piston is used to provide the treated water return valve 313 and the brine piston includes a notch 317 to allow the oxidant charge during brine draw and rinse positions, as shown in FIGS. 3D and 3E, respectively.

In FIG. 3A the valve cycle actuator 329 is in the service cycle position (e.g., the piston rod is at a home position), which closes the treated water return valve 313. In this position, the oxidant control valve 300 allows supply water 303 to flow into the supply water inlet passage 320 through the pressure opening device 315 into the oxidant control valve 300 and allows supply water 303 to flow through the parallel fluid passage 308 around the pressure opening device 315 through the venturi 312 into the oxidant control valve 300 rejoining the supply water 303 from the pressure opening device 315.

In FIG. 3B, the valve cycle actuator 329 is in the oxidant charge during service cycle position, which opens the treated water return valve 313. In this position, the oxidant control valve 300 allows supply water 303 to flow into the supply water inlet passage 320 and the parallel fluid passage 308. In this position, the oxidant control valve 300 also allows treated oxidized water 306 to pass through the opened return valve 313 and the oxidant device 330 and into the venturi 312 to mix with the supply inlet water 303, which forms oxidized water 316 that is passed through the valve 300 into the first tank passage 322.

In FIG. 3C, the valve cycle actuator 329 is in the backwash cycle position, which closes the treated water return valve 313. In this position, the oxidant control valve 300 allows supply water 303 to flow into the service water outlet passage (not shown) and into the second tank passage 323 while also allowing the supply water 303 to flow through the parallel fluid passage 308 and out the drain passage 325. The valve 300 also allows the water to flow from the first tank passage 322 to the drain passage 325.

In FIG. 3D, the valve cycle actuator 329 is in the oxidant charge cycle position, which opens the treated water return valve 313. In this position, the oxidant control valve 300 allows supply water 303 to flow into the supply water inlet passage 320 and the parallel fluid passage 308. In this position, the oxidant control valve 300 also allows a portion of the treated oxidized water 306 to pass through the opened return valve 313 and the oxidant device 330 and into the venturi 312 to mix with the supply inlet water 303, which forms oxidized water 316 that is passed through the valve 300 into the first tank passage 322. The oxidant control valve 300 also allows a portion of the treated water 306 to pass from the second tank passage 223 to the drain passage 225. In this position, the valve 300 also directs the supply water 303 that passes in through the supply water inlet passage 220 to the outlet passage (not shown).

In FIG. 3E, the valve cycle actuator 329 is in the oxidant charge during rinse cycle position, which opens the treated water return valve 313. In this position, the oxidant control valve 300 allows supply water 303 to flow into the supply water inlet passage 320 and the parallel fluid passage 308. In this position, the oxidant control valve 300 also allows a portion of the treated oxidized water 306 to pass through the opened return valve 313 and the oxidant device 330 and into the venturi 312 to mix with the supply inlet water 303, which forms oxidized water 316 that is passed through the valve 300 into the first tank passage 322. This oxidant charge during rinse prevents the untreated supply water 303 from depleting the oxidant charge achieved during the oxidant charge cycle. In this position, the oxidant control valve 300 also allows a portion of the treated water 306 to pass from the second tank passage 223 to the drain passage 225, directs a portion of the supply water 303 that passes in through the supply water inlet passage 320 to the outlet passage (not shown), and passes a portion of the supply water 303 to the first tank passage 322.

In the illustrated embodiment, the valve cycle actuator 329 moves in the direction of arrow 301 sequentially from the service cycle position (FIG. 3A) to the oxidant charge during service cycle position (FIG. 3B) to the backwash cycle position (FIG. 3C) to the oxidant charge cycle (FIG. 3D) and then to the oxidant charge during rinse cycle position (FIG. 3E). The direction of the valve cycle actuator piston 329 may then be reversed to move back to the service cycle position (FIG. 3A). In one embodiment, a drive mechanism may be coupled to the valve actuator 329 (e.g., the piston rod) to cause the valve actuator 329 to move to each of the cycle positions. The drive mechanism may include, for example, a drive wheel that rotates to cause linear movement of the valve actuator 329 (e.g., using a lead screw to provide linear actuation), one or more gears engaging the drive wheel, and a motor for driving the gear(s).

FIG. 3F shows another embodiment of an oxidant control valve 300′ corresponding to the embodiment of the water treatment system 200′ shown in FIG. 2F. In this embodiment, the parallel fluid passage 308 is fluidly coupled directly to the supply water inlet 320 to allow the oxidant charge to be provided to the supply water 303 entering the valve 300. FIG. 3F shows this embodiment of an oxidant control valve 300′ in the oxidant charge during service cycle position. This embodiment of an oxidant control valve 300′ may also move through the other cycle positions similar to the oxidant control valve 300 shown in FIGS. 3B-3E and described above.

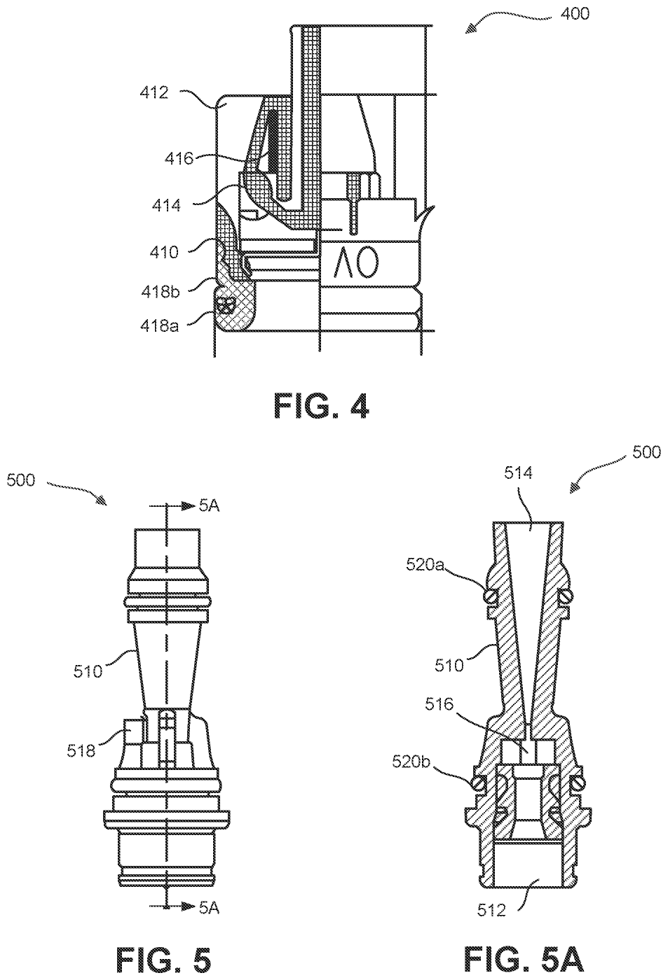

FIG. 4 shows in greater detail one embodiment of a check valve 400 that may be used as the pressure opening device (e.g., pressure opening device 215, 315) in an oxidant control valve. The check valve 400 includes a cap 410, a guide 412, a plunger 414, a spring 416 and seals 418a, 418b. The check valve 400 may thus be located and sealed within the supply water inlet passage 320, shown in FIG. 3A, such that the plunger 414 is movable within the guide 412 against the force of the spring 416 when sufficient opening pressure is applied, thereby allowing the liquid to flow through the check valve 400. Other types of check valves or pressure opening devices may also be used.

FIG. 5 and FIG. 5A shows one embodiment of a venturi 500 in greater detail. The venturi 500 includes a body portion 510 defining an inlet 512, an outlet 514, a throat area 516, a side port 518, and seals 520a and 520b. The venturi 500 may thus be located and sealed within the venturi body 311, shown in FIG. 3B, such that the supply water 303 passes into the inlet 512, through the throat area 516 and out of the outlet 514. The side port 518 provides a fluid connection so that the reduced pressure zone created at the throat region 516 can be fluidly coupled to a treated water return passage (e.g., treated water return passage 324).

FIGS. 6A-6E show an embodiment of a control valve 600 (also referred to as a control valve assembly) that may be used in a water treatment system configured to provide an oxidant charge into the supply water and an air charge into the control valve 600, such as the water treatment system 100E shown in FIG. 1E and described above. The control valve 600 includes a valve body 610, a supply water inlet passage 620, a service water outlet passage (not shown), first and second tank passages 622, 623, a treated water return passage 624, a parallel fluid passage 608, and a drain passage 625. The parallel fluid passage 608 is fluidly coupled to the treated water return passage 624 to allow treated oxidized water 606 to return to the supply water 603 while in service, as shown in FIG. 6B. A valve cycle actuator 629 moves within the valve body 610 to provide a fluid connection between the passages 608, 620-625.

The control valve 600 also includes a pressure opening device 615, such as a check valve, located in the supply water inlet passage 620, an oxidant device 630 located in the treated water return passage 624 and a first venturi 612 located in the parallel fluid passage 608. The pressure opening device 615 causes at least a portion of the supply water 603 to flow into the parallel fluid passage 808 and through the first venturi 612. A treated water return valve 613 controls the flow of treated water from the second tank passage 623 to the treated water return passage 624. In an embodiment, a brine piston is used to provide the treated water return valve 613 and the brine piston includes a notch 617 to allow the oxidant charge during the rinse position, as shown in FIG. 6E.

In this embodiment, the parallel fluid passage 608 is fluidly coupled to the supply water inlet passage 620 to provide an oxidant charge to the supply water 603 and the oxidant control valve 600 further includes a first one-way valve 642 into the oxidant device 630 and a second one-way valve 644 into an air inlet 640. This embodiment of the oxidant control valve 600 further includes a second, internal venturi 648 to cause the air to be drawn in through the air inlet 640 and mixed with supply water. This embodiment of the oxidant control valve 600 may thus provide an oxidant charge into the supply water 603 and an air charge into the control valve 600, for example, as described above in connection with FIG. 1E. FIG. 6D shows the air charge cycle where the supply water 603 flows through the internal venturi 648 and causes the air charge 646 to be drawn in through the air inlet 640 and the first one-way valve 642. The air charge 646 passes through the control valve 600 to a venturi throat area of the internal venturi 648, where the air is mixed with the supply water flowing through the internal venturi 648.

In the illustrated embodiment, the valve cycle actuator 629 moves in the direction of arrow 601 sequentially from a service cycle position (FIG. 6A) to an oxidant charge during service cycle position (FIG. 6B) to a backwash cycle position (FIG. 6C) to the air charge cycle (FIG. 6D) and then to an oxidant charge during rinse cycle position (FIG. 6E). The direction of the valve cycle actuator piston 629 may then be reversed to move back to the service cycle position (FIG. 6A). The service cycle, oxidant charge during service cycle, backwash cycle, and oxidant charge during rinse cycle are similar to those described above in connection with FIGS. 3A-3C and 3E.

FIGS. 7A-7E show an embodiment of a water treatment system 700 that is configured to provide an oxidant charge and an air charge into a treatment tank 714, for example, as described above in connection with FIG. 1F. The water treatment system 700 includes a control valve 710 (also referred to as a valve assembly) coupled to a treatment tank 714 and to a supply line 702 and a delivery line 704. The oxidant control valve 710 includes a supply water inlet passage 720, a service water outlet passage 721, first and second tank passages 722, 723, and a drain outlet passage 725. The supply water inlet passage 720 may be fluidly coupled to the water supply line 702 and the service water outlet passage 721 may be fluidly coupled to the water delivery line 704. The first and second tank passages 722, 723 are coupled to the water treatment tank 714 for passing water in to and out of the tank 714. In one embodiment, the second tank passage 723 is coupled to a conduit 726 that extends into filter media 717 proximate the bottom region of the water treatment tank 214. The drain outlet passage 225 may be coupled to a drain for directing water from the tank 714 to the drain.

The control valve 710 also includes a pressure opening device 715 fluidly coupled to the supply water inlet passage 720, a parallel fluid passage 708 in parallel with the pressure opening device 715, a venturi 712 fluidly coupled to the parallel fluid passage 708, a treated water return passage 624 fluidly coupled to a venturi throat area 732 of the venturi 712, and an oxidant device 730 fluidly coupled to the treated water return passage 724. A treated water return valve 713 in the control valve 710 is coupled to the treated water return passage 224 to control the flow of water to the oxidant device 230.

This embodiment of the control valve 710 further includes an air inlet 740 and a one-way valve 742 that allow air to pass into the throat area 732 of the venturi 712 to provide an air charge during an air charge cycle. In this embodiment of the control valve 710, the parallel fluid passage 708 is fluidly coupled into the treatment tank 714 to allow the oxidant charge and the air charge directly into the tank 714.

Thus, the control valve 710 controls the flow of supply water 703, oxidant water 731, oxidized water 716, and treated oxidized water 706 in to and out of the water treatment tank 714, while the oxidant device 730 provides oxidation, as shown in FIG. 7B. The water treatment tank 714 may contain filter media 717 for filtering the oxidized water, whereby the oxidized water 716, when in contact with the filter media 717, can oxidize the filter media 717 and be treated by the filter media 717 such that the oxidized water 716 becomes treated oxidized water 706.

The control valve system 710 may also include a valve cycle actuator and may operate similar to the control valve systems described above by moving the valve actuator between different positions that provide fluid connections between the passages 708, 720-725 according to various water treatment cycles or operations, as illustrated in FIGS. 7A-7E. A controller 718 may also be coupled to the control valve 710 to control operation of the control valve 710 (e.g., movement of the valve cycle actuator) and initiation of the cycles of operation, for example, according to a programmed schedule. For example, FIG. 7A illustrates the flow with the control valve system 710 in a service position, FIG. 7B, illustrates the flow with the control valve system 710 in an oxidant charge during service position, FIG. 7C illustrates the flow with the control valve system 710 in a backwash position, FIG. 7D illustrates the flow with the control valve system 710 in an air charge position, and FIG. 7E illustrates the flow with the control valve system 710 in an oxidant charge during rinse position.

In the service position, as shown in FIG. 7A, the treated water return valve 713 is closed to prevent water from entering the treated water return passage 724 and the control valve system 710 directs treated water to the outlet passage 721.

In the oxidant charge during service position, as shown in FIG. 7B, the treated water return valve 713 is open and the control valve system 710 directs treated water 706 into the treated water return passage 724 for an oxidant charge. The treated water is oxidized in the oxidant device 730 to form oxidant water 731, the oxidant water 731 is mixed with supply water 703 in the venturi 712, and the oxidized water is directed by the parallel passage 708 directly into the treatment tank 714. The control valve system 710 also directs treated water 706 to the delivery passage 721 and directs supply water to the treatment tank 714.

In the backwash position, as shown in FIG. 7C, the treated water return valve 713 is closed and the control valve system 710 directs water from the tank 714 to the drain passage 725 while directly supply water 703 into the tank 714 and to the delivery passage 721.

In the air charge position, as shown in FIG. 7D, the treated water return valve 713 is closed to prevent water from entering the treated water return passage 724 and the control valve system 710 allows air to pass into the air inlet 740. The low pressure at the venturi throat area 732, as a result of the supply water 703 flowing through the venturi 712, causes the air 746 to be drawn into the air inlet 740 through the one-way valve 742. The venturi 712 mixes this air with the supply water 703 and the parallel passage 708 directs the aerated water into the treatment tank 714, thereby providing an air charge.

In the oxidant charge during rinse position, as shown in FIG. 7E, the treated water return valve 713 is open and the control valve system 710 directs a portion of the treated water 706 into the treated water return passage 724 for an oxidant charge. The treated water is oxidized in the oxidant device 730 to form oxidant water 731, the oxidant water 731 is mixed with supply water 703 in the venturi 712, and the oxidized water 716 is directed by the parallel passage 708 directly into the treatment tank 714. The control valve system 710 also directs a portion of the treated water to the drain passage 725 and directs supply water both to the treatment tank 714 and the delivery passage 721.

Accordingly, a control valve system, consistent with embodiments of the present disclosure, improves oxidation treatment of water by allowing only treated water to be oxidized in an oxidant device. The control valve system also allows an oxidant charge to be provided while a water treatment system is in service and during a rinse cycle. The control valve system further allows the oxidant device to be used in a water treatment system that also provides an air charge.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. A water treatment system comprising:
at least one water treatment tank including a filter media for filtering water while in service; and
an oxidant control valve coupled to the water treatment tank for directing water in to and out of the water treatment tank during different operation cycles, the oxidant control valve including an oxidant device and being configured to provide treated water from the water treatment tank to the oxidant device, wherein the treated water is oxidized to form oxidant water that provides an oxidant charge.

2. The water treatment system of claim 1 wherein the oxidant control valve is configured to prevent untreated water from being directed to the oxidant device.

3. The water treatment system of claim 1 wherein the oxidant control valve is configured to mix the oxidant water with supply water to form oxidized water and to direct the oxidized water back in to the treatment tank to provide the oxidant charge.

4. The water treatment system of claim 3 wherein the oxidant control valve is configured to direct the oxidized water into the supply water before passing into the treatment tank.

5. The water treatment system of claim 3 wherein the oxidant control valve is configured to direct the oxidized water directly into the treatment tank.

6. The water treatment system of claim 1 wherein the oxidant control valve includes an air inlet and is configured to provide an air charge.

7. The water treatment system of claim 6 wherein the oxidant control valve is configured to provide the air charge into the supply water.

8. The water treatment system of claim 6 wherein the oxidant control valve is configured to provide the air charge directly into the treatment tank.

9. The water treatment system of claim 1 wherein the oxidant control valve includes a venturi configured to create a low-pressure zone for causing the treated water from the water treatment tank to be provided to the oxidant device.

10. The water treatment system of claim 9 wherein the venturi mixes the oxidant water and the supply water to form oxidized water.

11. The water treatment system of claim 1 wherein the oxidant control valve includes a treated water return passage and a treated water return valve, wherein the oxidant device is fluidly coupled to the treated water return passage and the treated water return valve is configured to control flow of treated water from the treatment tank to the treated water return passage and the oxidant device.

12. The water treatment system of claim 11 wherein the oxidant control valve further includes a pressure opening device fluidly coupled to a supply water inlet passage, a parallel fluid passage in parallel with the pressure opening device, and a venturi fluidly coupled to the parallel fluid passage, wherein the treated water return passage is fluidly coupled to a venturi throat area of the venturi.

13. An oxidant control valve system comprising:
a valve assembly configured to be coupled to a water treatment tank, the valve assembly comprising:
a supply water inlet passage configured to receive water from a water supply;
a service water outlet passage configured to direct water to a service water system;
first and second tank passages configured to direct water in to or out of the water treatment tank;
a treated water return passage to control flow of water from the treatment tank to an oxidant device for oxidizing the treated water;
a parallel fluid passage configured to divert at least some of the water from the supply water inlet passage and coupled to the treated water return passage to mix with oxidant water to form oxidized water and to supply the oxidized water to the water treatment tank;
a drain outlet passage configured to direct water from the water treatment tank to a drain; and
a valve cycle actuator configured to provide fluid connections between the passages based on different positions of the valve cycle actuator during different operation cycles, wherein at least one of the operations cycles includes providing treated water from the water treatment tank to the treated water return passage during an oxidant charge cycle.

14. The oxidant control valve system of claim 13 wherein the parallel fluid passage includes a venturi configured to create a low-pressure zone for causing the treated water from the water treatment tank to be directed to the treated water return passage and for mixing the oxidant water with supply water to form the oxidized water during the oxidant charge cycle.

15. The oxidant control valve system of claim 13 further comprising a treated water return valve that allows the treated water to be directed to the treated water return passage and that prevents untreated water from being directed to the treated water return passage.

16. The oxidant control valve system of claim 13 further comprising an air inlet coupled to the treated water return passage to provide an air charge when the valve cycle actuator is positioned for an air charge cycle.

17. The oxidant control valve system of claim 16 wherein the air inlet is also fluidly coupled to the venturi, and wherein the venturi is configured to mix air with the supply water when the valve cycle actuator is positioned for the air charge cycle.

18. The oxidant control valve system of claim 13 further comprising a controller coupled to the control valve assembly to control movement of the valve cycle actuator through the different positions to provide the different operation cycles.

19. A method of operating a water treatment system, the method comprising:
treating the water in the water treatment system by directing water from a water supply to a water treatment tank;
providing treated water from the water treatment tank to an oxidant device to oxidize the treated water; and
supplying the oxidized treated water back to the water treatment tank mixed with supply water.

20. The method of claim 18, wherein the treated water is provided to the oxidant device without using a pump.
